(19) United States
(12) Patent Application Publication
(10) Pub. No.: US 2008/0126127 A1
(43) Pub. Date: May 29, 2008

(54) Method and System for Estimating Usage of Blood Products

(76) Inventor: Alec D. Bobroff, Norfolk, MA (US)

Correspondence Address: BROMBERG & SUNSTEIN LLP, 125 SUMMER STREET, BOSTON, MA, 02110-1618, US

(21) Appl. No.: 11/947,399

(22) Filed: Nov. 29, 2007

Related U.S. Application Data
(60) Provisional application No. 60/867,670, filed on Nov. 29, 2006.

(51) Int. Cl. G06Q 50/00; G06F 17/00; G06Q 10/00

(52) U.S. Cl. 705/2

(57) ABSTRACT

A method for estimating blood and blood product usage in a facility comprising obtaining a first set of publicly available data, obtaining a second set of publicly available data, and querying a user for data specific to the facility. The method further includes using the data from the first set of publicly available data as default data for data not provided by the user, and estimating an amount of blood product usage based upon the first and second set of publicly available data and data entered by the user.

### PRIORITY

This patent application claims priority from provisional U.S. patent application No. 60/867,670, filed Nov. 29, 2006, entitled, “Method and System for Estimating Usage of Blood Products,” assigned attorney docket number 1611/A47, and naming Alec D. Bobroff as inventor, the disclosure of which is incorporated herein, in its entirety by reference.

### TECHNICAL FIELD

The present invention relates to blood and blood product usage, and particularly to systems and methods for estimating and tracking blood product usage.

### BACKGROUND ART

Due to the large quantities used, blood and blood products make up a significant portion of a hospitals operating cost each year. Many surgeries performed at a hospital requires the use of blood and blood product. The amount of blood required for a surgery varies, and largely depends on the type of surgery, complications encountered during the surgery, the presence or absence of blood salvage equipment, and the length of post-operative stay. Although hospitals typically track the usage of nearly every item used in a hospital, including medications, syringes, and disposables, many hospitals do not currently track or estimate blood and blood product usage.

To reduce some of the costs associated with blood and blood products, many hospitals utilize blood salvage systems to reduce the amount of outside blood and blood product used during surgery. Blood salvage systems suction blood and other fluids from a surgical site and draw them into a reservoir. These fluids are then typically drawn from the reservoir into a centrifuge disk, which is then spun so as to separate out the red blood cells (RBCs) from the plasma and other fluids. In some cases, the plasma and other fluids are directed to a waste bag. The RBCs are then washed in the centrifuge disk with saline. After washing, the saline is separated from the RBCs and directed to the waste bag, and the washed RBCs may be retransfused into the patient. Returning the patient's own, recovered blood reduces the amount of blood that the hospital needs to acquire and use during surgery. In addition, because it is the patient's own blood, the risk of complications, infections, and negative reactions are greatly reduced. There are a variety of commercial blood salvage systems available, such as the OrthoPAT® Surgical Blood Salvage System, the CardioPAT™ Surgical Blood Salvage System and the Cell Saver® Blood Salvage System, all of which are sold by Haemonetics Corporation of Braintree, Mass.

The use of blood salvage equipment adds to the complexity of tracking and estimating blood and blood product usage because the blood salvage equipment introduces an additional variable (i.e. how much blood is salvaged and retransfused into the patient.) Given the large quantity of blood and blood products used each year, and the high cost associated with them, it would be beneficial for a hospital to track blood and blood product usage and minimize blood and blood product waste.

### SUMMARY OF THE INVENTION

In accordance with one aspect of the present invention, a method is provided for the estimation of blood and blood product usage in a facility. The method includes obtaining a first set of publicly available data, obtaining a second set of publicly available data, and querying a user for data specific to the facility. The facility-specific data may include the cost of blood products and number of surgical procedures performed by a hospital. The first publicly available data set may include an average units of blood used per procedure and an average length of stay. Data from the first set of publicly available data may be used as default data for data not provided by the user. The method may also include estimating an amount of blood product usage based upon the first and second set of publicly available data and data entered by the user.

In various embodiments, the method may estimate an amount of blood usage by performing a mathematical function to determine a cost of operation. The method may also estimate an amount blood product usage by performing a mathematical function to determine cost savings. In some embodiments, the method may generate a report containing the estimated blood product usage.

In accordance with another aspect of the present invention, a computer program product, containing computer code thereon and readable by a computer, for estimating blood product usage in a facility is provided. The computer code may include computer code for obtaining a first set of publicly available data, obtaining a second set of publicly available data, and querying a user for data specific to the facility. In some embodiments the computer program product may also contain computer code for using data from the first set of publicly available data as default data for data not provided by the user.

In some embodiments, the computer program product may include computer code for estimating an amount of blood product usage, based upon the first and second set of publicly available data and data entered by the user. The computer program product may also include computer code for performing a mathematical function to determine a cost of operation or cost savings. The computer program product may also generate a report containing the estimated blood product usage.

In various other embodiments, the data specific to the facility includes the cost of blood product, a number of surgical procedures performed by a hospital. Additionally, the first set of publicly available data may include an average units of blood used per procedure and/or an average length of stay.

In accordance with other embodiments of the present invention a system for estimating usage of blood and blood product in a facility includes a first data set module and a second data set module. The first and second data set modules are configured to obtain the first set of publicly available data and the second set of publicly available data, respectively. The system may also include a user query module configured to query a user for data specific to the facility, and a default data module configured to detect whether the user has failed to provide any data specific to the facility and use data from the first publicly available data as default data for the data not provided by the user. Additionally, the system may also have a blood usage estimation module configured to estimate an amount of blood product usage based upon the first and second set of publicly available data and data entered by the user. The blood usage estimation module may also perform a mathematical function to determine a cost of operation or a cost savings.

The data specific to the facility may include the cost of blood product or the number of surgical procedures performed by a hospital. The first set of publicly available data may include an average units of blood used per procedure and/or an average length of stay.

In accordance with other embodiments, the system may also include a report generation module configured to generate a report containing the estimated blood product usage. Additionally, the system may also include a user interface having a display device and a user input device (e.g., a keyboard). The user interface may be configured to display queries on the display device and receive inputs from the user via the user input device. For example, the inputs from the user via the user input device may include the data specific to the facility. The system may also include a printer configured to print the blood estimation report generated by the report generation module.

In accordance with still other embodiments, a computer-implemented method for use in controlling stocks of blood and blood products in a medical facility includes obtaining usage data on the usage of blood for a number of different procedures, obtaining salvage data on blood salvage rates for said procedures, and obtaining facility-specific data on the anticipated procedures to be performed at the medical facility over a period of time. Once obtained, the computer implemented method may process the data to determine a numerical estimate of blood usage for the medical facility over said period of time and determine a blood and blood products stock requirement for the medical facility over said period of time. The stock requirements may be dependent on the estimate of blood usage.

The usage data discussed above may include a first usage data set and a second usage data set, the first usage data set and the second usage data set may include publicly available data. Likewise the salvage data may include a first salvage data set and a second salvage data set which may be publicly available data. The facility-specific data may also include the cost of blood and blood product to the facility and the number of surgical procedures performed by the hospital/facility. The usage data may include an average units of blood used per procedure and/or an average length of stay per procedure. The computer-implemented method may also use data from the first usage data set as default data for any missing facility-specific data and may generate a report containing the estimate of blood usage obtained and the blood and blood products stock requirement. The computer implemented method may also process the data to determine a numerical estimate of a cost savings created by salvaging blood and blood products.

In accordance with another embodiment of the present invention a computer system for use in controlling stocks of blood and blood products in a medical facility includes means for obtaining usage data on the usage of blood for a number of different procedures, means for obtaining salvage data on blood salvage rates for said procedures, and means for obtaining facility-specific data on the anticipated procedures to be performed at the medical facility over a period of time. The computer system may also have means for processing the obtained data obtained to determine a numerical estimate of blood usage for the medical facility over said period of time, and means for determining a blood and blood products stock requirement for the medical facility over said period of time in dependence on the estimate of blood usage.

In some embodiments the usage data includes a first usage data set and a second usage data set. The first usage data set and the second usage data set may be publicly available data. The facility-specific data may also include the facility's cost of blood and blood product and a number of surgical procedures performed by a hospital. The usage data may include an average units of blood used per procedure and an average length of stay per procedure

The computer system may also have means for using data from the first usage data set as default data for missing facility-specific data, and means for generating a report containing the estimate of blood usage and the blood and blood products stock requirement. The computer system may also include means for processing the usage data, the salvage data, and the facility-specific data to determine a numerical estimate of a cost savings created by salvaging blood and blood products.

### BRIEF DESCRIPTION OF THE DRAWINGS

The foregoing features of the invention will be more readily understood by reference to the following detailed description, taken with reference to the accompanying drawings, in which:

FIG. 1 shows a process diagram of a system in accordance with an embodiment of the present invention.

FIG. 2 shows an exemplary screen shot of a login form from a system in accordance with an embodiment of the present invention.

FIG. 3 shows an exemplary screen shot of a Main Menu from a system in accordance with an embodiment of the present invention.

FIG. 4 shows an exemplary screen shot of an Administrative Menu from a system in accordance with an embodiment of the present invention.

FIG. 5 shows an exemplary screen shot of a User Maintenance Form from a system in accordance with an embodiment of the present invention.

FIG. 6 shows an exemplary screen shot of a User Groups Maintenance Form from a system in accordance with an embodiment of the present invention.

FIG. 7 shows an exemplary screen shot of a Proposal Templates Maintenance Form from a system in accordance with an embodiment of the present invention.

FIG. 8 shows an exemplary screen shot of a Survey Templates Maintenance Form from a system in accordance with an embodiment of the present invention.

FIG. 9 shows an exemplary screen shot of a Survey Templates Questions Master Maintenance Form from a system in accordance with an embodiment of the present invention.

FIG. 10 shows an exemplary screen shot of a Products Maintenance Form from a system in accordance with an embodiment of the present invention.

FIG. 11 shown an exemplary screen shot of a Survey Answers Entry Form from a system in accordance with an embodiment of the present invention.

FIG. 12 schematically shows a blood usage estimation system in accordance with embodiments of the present invention.

FIG. 13 schematically shows the blood usage estimation system of FIG. 12 with various peripherals, in accordance with embodiments of the present invention.

### DETAILED DESCRIPTION OF SPECIFIC EMBODIMENTS

In embodiments of the present invention, a system for estimating blood and blood product usage is provided. In certain embodiments, the system receives data from a variety of sources including publicly available information, such as periodicals and medical journals, and facility specific information inputted by a user. From this information, the system is able to estimate blood and blood product usage, including cost and cost savings. In a preferred embodiment, if a user is unable to provide a particular piece of information, the system may use information obtained from the publicly available sources as a default. For example, if a user is unable to provide information regarding the average length of stay for a particular surgery, the system may use an average length of stay obtained from the publicly available information.

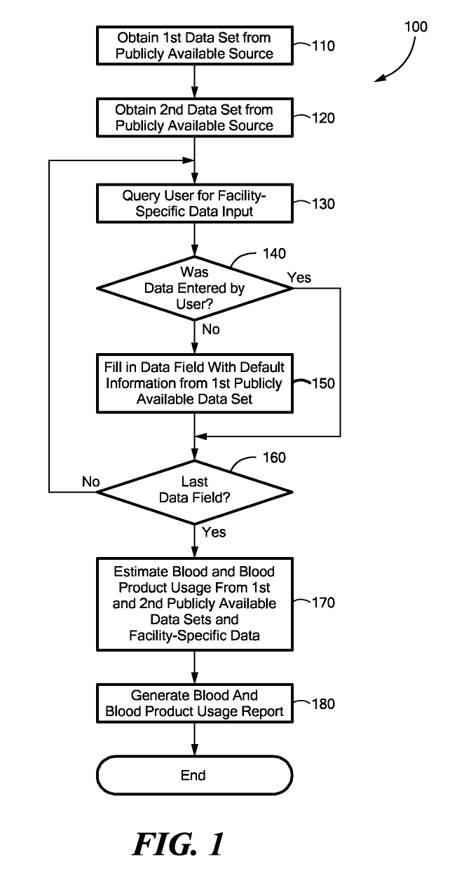

FIG. 1 show a process flowchart of a method 100 for estimating and tracking blood and blood product usage in accordance with an embodiment of the present invention. The method 100 uses a variety of sources of information to track and estimate blood usage including facility-specific data and publicly available data. First, the method 100 obtains a first set of data from publicly available information 110. Next, the method obtains a second set of data from publicly available information 120. The first and second sets of data can be obtained from a variety of publicly available sources of information including, but not limited to, periodicals, medical journals, and research studies. The type of information contained in the first data set can include such things as an the average cost of a unit of blood or blood product, cost of disposables associated with blood transfusions, average amount of blood used for a particular surgery, and an average amount of blood discarded by hospitals during a given time period (i.e. per month or per year). The second set of data from publicly available sources may include information regarding the cost and efficiency (i.e. salvage rates) of blood salvaging equipment, hematocrit levels of salvaged blood, average increase in length of stay due to complications arising from allogenic blood transfusions, rate of infections, and percentage of patients needing allogenic blood transfusion.

Once the method 100 has obtained the first and second sets of publicly available data 110, 120, the method 100 will query the user for additional, facility-specific information 130. This step allows the user to tailor the usage estimates and resulting report to their hospital by inputting information specific to the hospital. For example, the user/hospital/facility may pay more or less per unit of blood than the average price obtained from the publicly available information. In such a case, the user can input their facility-specific information (i.e. their cost). The facility-specific information can be general information such as the name and address of a hospital or more specific information such as the number of surgical procedures performed, the cost per unit of blood, the average length of stay after a procedure, and whether the hospital has any blood processing equipment that may reduce blood waste and consumption.

In many cases, a user may not have sufficient information to answer every query by the system. If the user is unable to fill in all of the facility-specific information fields 140, some embodiments of the present invention will use information from the first publicly available data set as defaults 150. In other words, the method 100 will fill in incomplete information fields with information from the first data set. For example, if a user is unable to answer a query regarding the hospitals cost per unit of blood, and the first publicly available data set contains an average cost per unit of $500, the method 100 will use the default value of $500 to fill in the unanswered query. The method 100 will continue the query 130 and default 150 steps until all necessary information fields contain a value 160.

Once facility-specific data or default data are entered into all essential data fields, the method 100 will estimate the blood and blood product usage 170. To estimate the usage, the method 100 will use the information entered by the user in step 130, the default data used to fill in any information not entered by the user 150, and the first and second data sets obtained from publicly available sources 110, 120. In some embodiments, the method 100 will then generate a report containing the usage information 180. The usage information and generated report may contain, among other things, estimated annual costs, projected usage for an upcoming time period (i.e. number of units needed for the next 6 months), and estimated annual cost savings after if blood processing equipment is used. The information is valuable to the hospital because the hospital can use the information to plan for procurement, optimize blood usage, minimize blood waste, perform a cost-benefit analysis for a piece of blood processing equipment, and plan upcoming surgeries based on the volume of blood currently in stock.

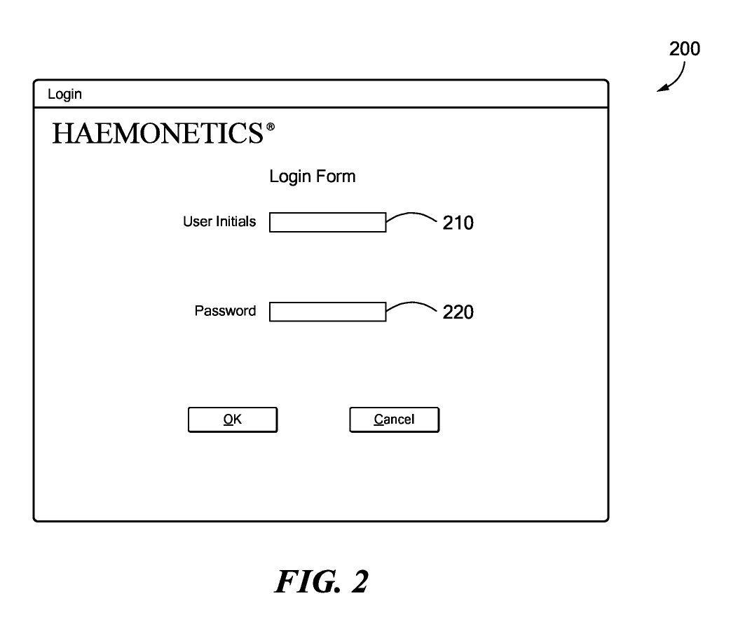

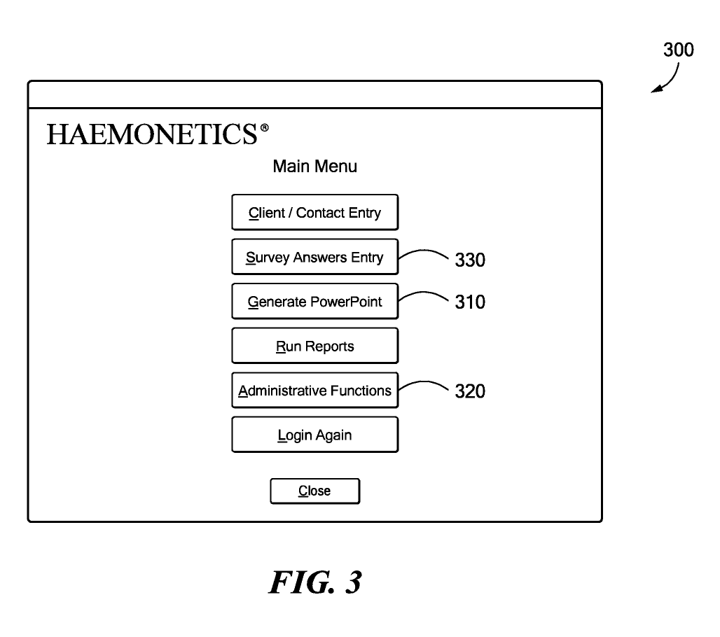

FIGS. 2-11 show exemplary screen shots from a system in accordance with embodiments of the present invention. FIG. 2 shows an exemplary login screen 200, which provides password protection for the system. On the login screen 200, the user must enter their login identification 210 and their password 220 to load any personalized settings, load rights and privileges, and enter the blood usage program and access the main menu page, FIG. 3.

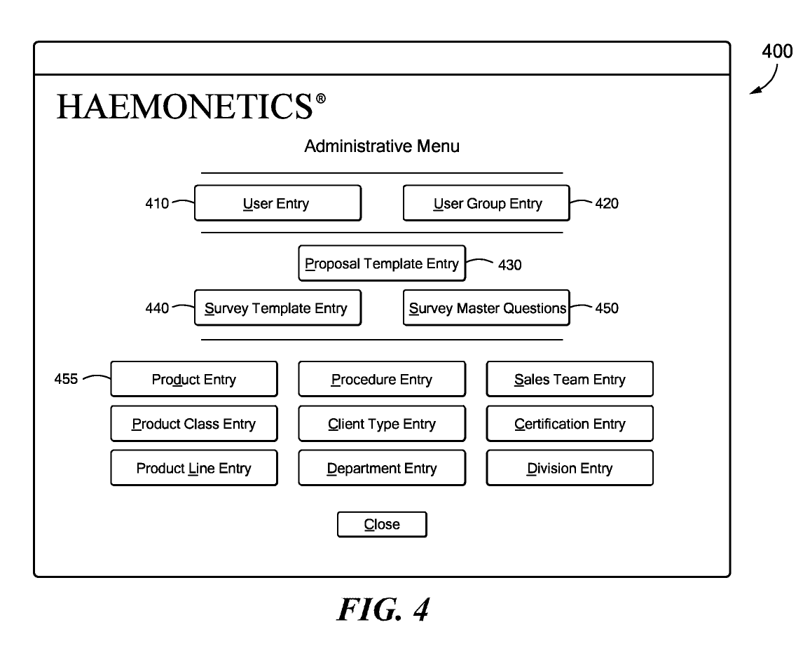

The main menu page 300 has several menu items to access and navigate through the other areas of the system. The “generate powerpoint” item 310 generates a report based on the inputted information, as described above. The “administrative functions” item 320 brings the user to an administrative menu 400, FIG. 4, which also contains various menu items which direct the user to several data entry pages. The data entry pages are used to provide the facility-specific data and create templates for the reporting features. The menu items and data entry pages are described, in turn, below.

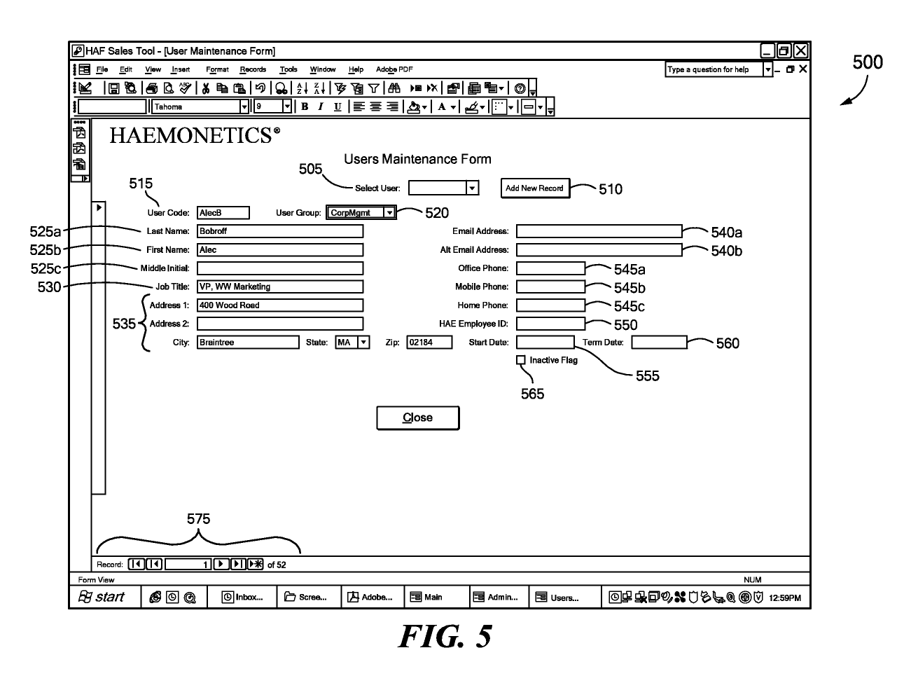

The User Entry menu item 410 directs the user to a User Maintenance form 500 as shown in FIG. 5. The user maintenance form 500 allows a user to select a user 505, add a new record 510, and enter a variety of user information including a user code 515, user group 520, user name 525a, 525b, 525c, user job title 530, user address 535, e-mail addresses 540a, 540b, telephone numbers 545a, 545b, 545c, employee ID 550, start date 555, and termination date 560. The user can also indicate whether the record is inactive by clicking on the inactive flag 565. Additionally, the user can navigate through existing records using the record navigation bar 575.

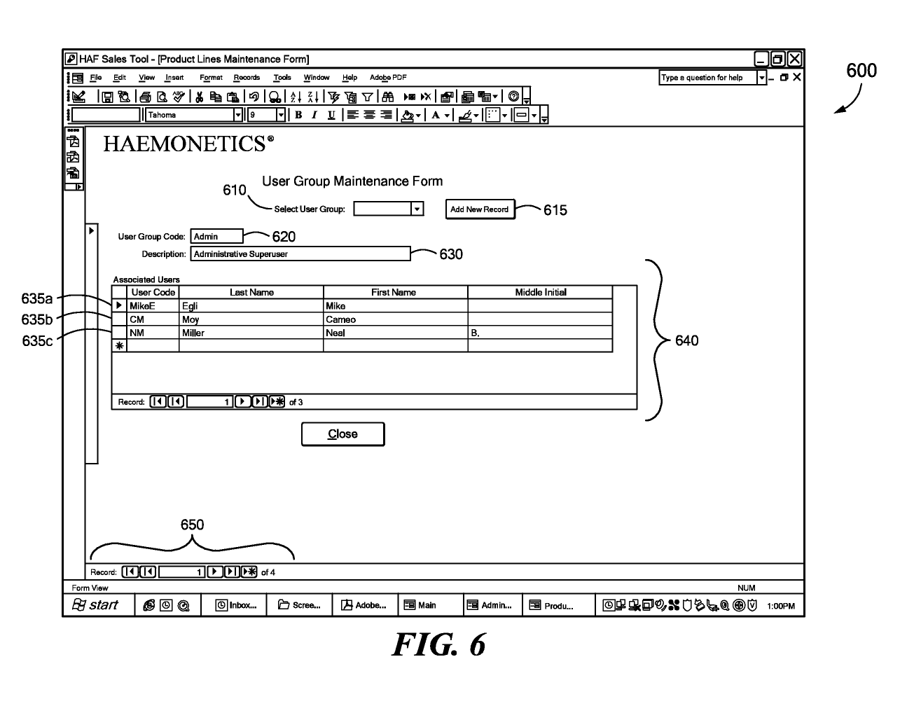

The User Groups Entry menu item 420 directs a user to the User Groups Maintenance form 600, FIG. 6. The User Groups Maintenance Form 600 allows a user to update existing user groups and add new user groups. The user may select an existing user group by using the user group drop down menu 610 or add a new group by selecting the add new record button 615. The user can then add or update group information including the user group code 620, and the group description 630. The group code and group description can be used to define the rights and privileges granted to each member of the group. The user can also add, update, or delete any associated users 635a, 635b, 635c using the associated users matrix 640. In a similar manner as the user maintenance form 500, the user can scroll through existing group records using the group record navigation bar 650.

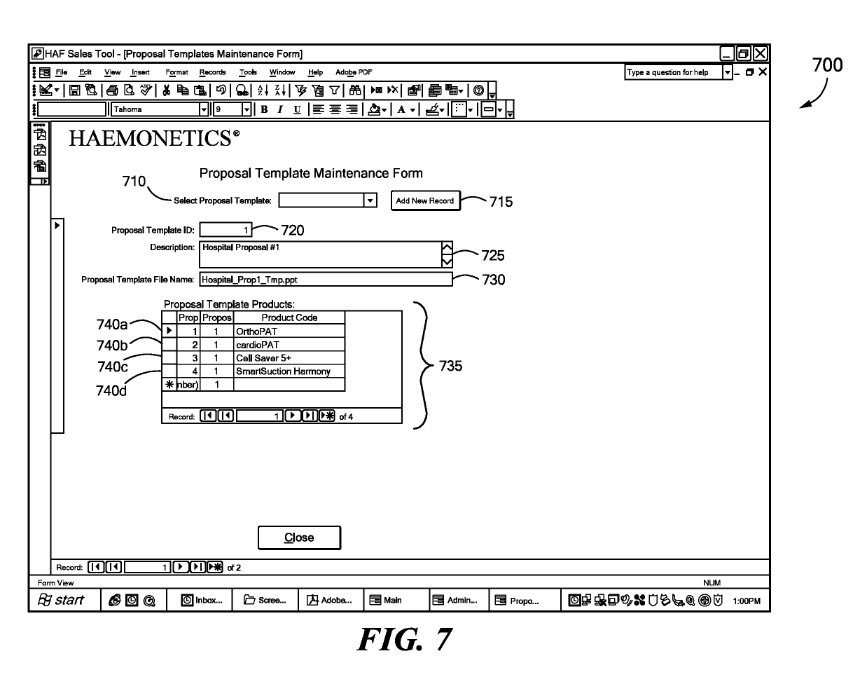

The Proposal Template Entry menu item 430, FIG. 4 directs the user to a Proposal Templates Maintenance Form 700, FIG. 7. The Proposal Templates Maintenance Form 700 allows a user to prepare a proposal or report. The Proposal Templates Maintenance Form 700 allows a user to access and update an exiting proposal template using the proposal template drop down menu 710 or create a new proposal template by selecting the add new record button 715. The user may then add or update proposal template information including a proposal template ID 720, a proposal description 725, and proposal template file name 730. The user may then add or update products to include in the proposal using the product matrix 735. For example, FIG. 7 shows a proposal containing 4 products—the OrthoPat 740a, CardioPat 740b, Cell Saver 5+ 740c, and SmartSuction Harmony™ 740d products. If a user wishes to add an additional product to the proposal template, the user need only add the information to the product matrix 735. Likewise, if a user does not wish to include the Cell Saver product 740c in the proposal, the user need only delete the entry from the product matrix 735.

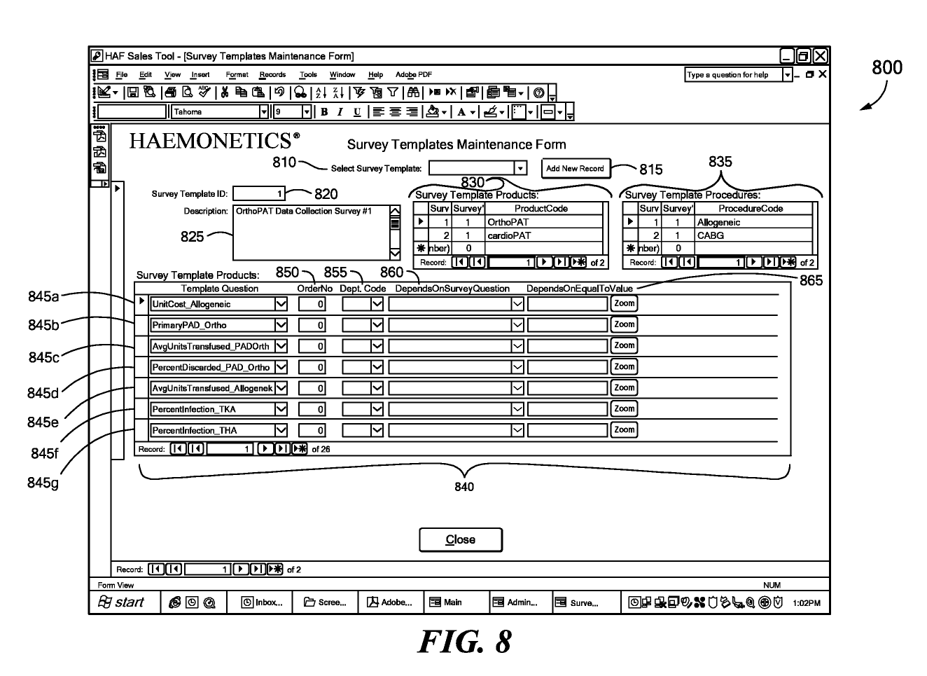

The Survey Templates Entry menu item 440, FIG. 4, directs the user to a Survey Templates Maintenance Form 800, FIG. 8, where the user can access, add, and/or update survey templates. The user may access existing survey templates using survey selection drop down menu 810, or add a new survey template by selecting the add new record button 815. The user may then add or update general survey template information including the survey template ID 820, and description 825. The user can then add or update products and procedures included in the survey, using product matrix 830, and procedure matrix 835. Using the survey question matrix 840, the user can select a series of template questions 845a-g which the user should answer to provide the system with facility-specific data and allow the system to provide a complete report tailored to the hospital. Users can enter answers to the template questions 845a-g into the Order Number 850, Department Code 855, Depends on Survey Question 860, and Depends on Equal to Value 865 fields. As discussed above, in some embodiments, the answer fields may automatically contain default information obtained from the publicly available data sets.

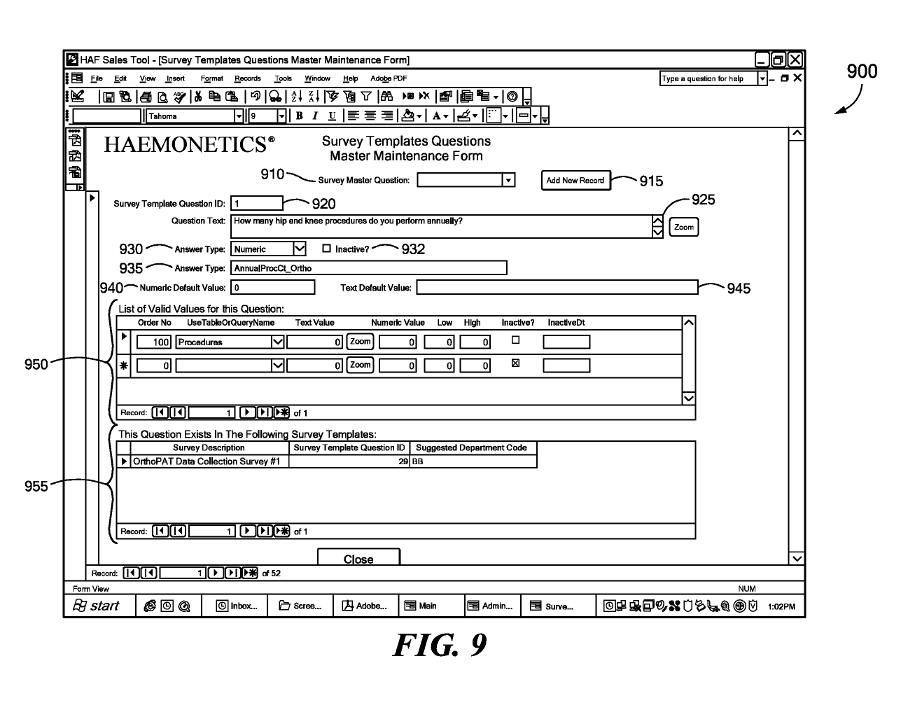

The Survey Master Questions menu item 450 shown in FIG. 4 brings the user to a Survey Templates Questions Master Maintenance Form 900, FIG. 9. The Survey Templates Questions Master Maintenance Form 900 allows a user to update and add template questions to be included in the survey question matrix 840, shown in FIG. 8. The user may update an existing question by selecting the master question from the survey master question drop down menu 910. Alternatively, the user may add a new question by selecting the add new record button 915 and filling in the corresponding input fields in the record. The record for each question includes a question ID 920, the question text 925, an answer type 930, an inactive indicator 932, a tag name 935, a numeric default value 940, a text default value 945, a list of valid values for the question 950, and a list of which survey templates contain the question 955. The ability to add or modify questions allows a user to modify the queries used to obtain the facility-specific data. In some embodiments, and as discussed above, the numeric default value 940 and text default value 945 are obtained from the data sets generated from the publicly available information. The tag name 935 is the name displayed in the template question column 842 shown in FIG. 8.

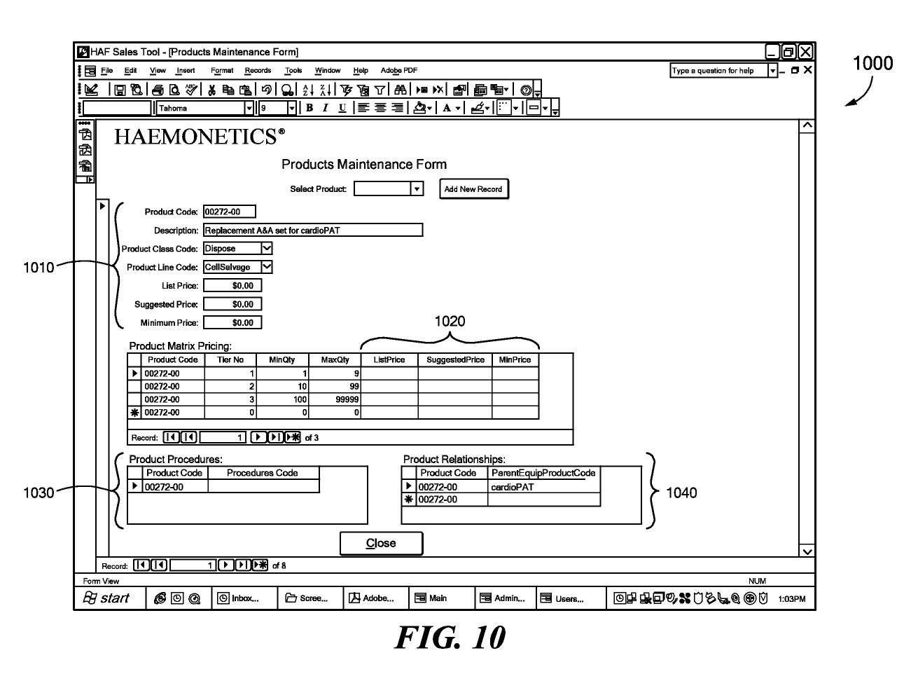

The Products Entry menu item 455 shown in FIG. 3 directs the user to a Products Maintenance Form 1000 shown in FIG. 10. The Products Maintenance Form allows a user to enter product information 1010, product pricing 1020, product procedures information 1030, and product relationship information 1040 (i.e. to which product does the product code correspond). The system can use this information to determine if the user/hospital will be able to obtain any cost savings by implementing blood salvage devices such as the CardioPat system by Haemonetics.

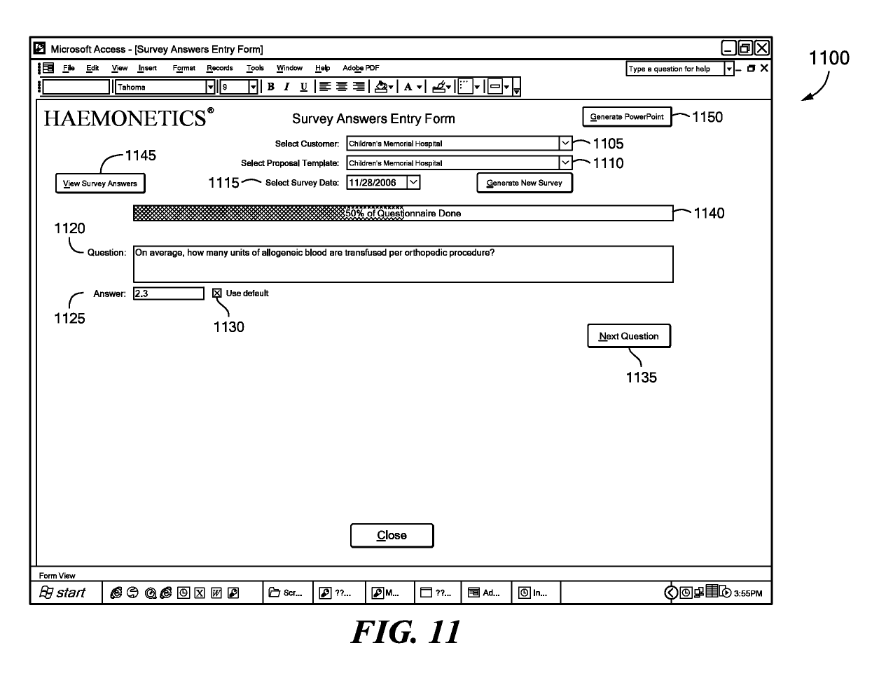

Returning to FIG. 3, a user may take a survey created by the Survey Templates Maintenance Form 900 and enter the facility-specific data by clicking the Survey Answers Entry icon 330 on the main menu 300. The Survey Answers Entry icon 330 will take the user through a series of Survey Answers Entry Form screens in which the user will answer the questions created and associated with the survey templates, as described above. FIG. 11 shows an exemplary Survey Answers Entry Form 1100. The Survey Answers Entry Form 1100 contains general information about the survey including customer information 1105, proposal template 1110, and survey date 1115. The Survey Answers Entry Form 1100 also contains a specific question, which the user may answer in the answer blank 1125. If the user does not wish to or is unable to provide facility-specific information, they may choose to use default data by clicking the use default box 1130. Once the question is answered, the user may move onto the next question by clicking the next question icon 1135. Progress meter 1140 displays how much of the survey is complete. At anytime, the user can view answers to previous questions by pressing the view survey answers icon 1145. The user can also create a PowerPoint presentation containing the answers by pressing the generate PowerPoint icon 1150.

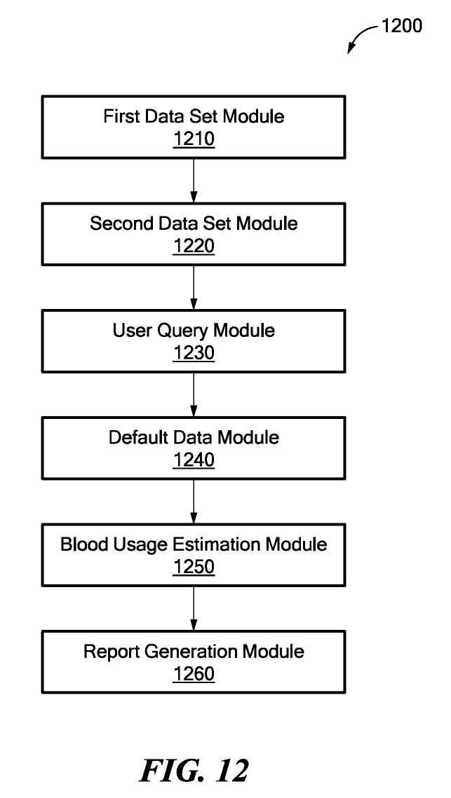

As mentioned above and as shown in FIG. 12, some embodiments of the present invention can be implemented as a system 1200. The system 1200 can include a variety of interconnected modules that perform the functions and steps discussed above with respect to FIG. 1. In particular, the system 1200 can include a first data set module 1210 and a second data set module 1220. The first and second data set modules 1210 and 1220 obtain and/or store the first and second data sets described above. For example, the first and second data set modules 1210 and 1220 can retrieve the first and second data sets from system memory (not shown), a system database, a publicly available database, or from another publicly available source (e.g., the internet).

Once the first and second data set modules 1210 and 1220 have obtained the publicly available data, the user query module 1230 will query the user to obtain facility-specific information. For example, the user query module may query the user for and collect information from the user regarding information such as the name and address of the facility/hospital, the facility's cost per unit blood, etc. If the user in unable to supply facility specific information in response to the query, the default data module 1240 will fill-in the missing information with data from the first publicly available data set (e.g., the data obtained/stored by the first data set module). In particular, the default data module 1240 may scan one of the user forms described above and shown in FIGS. 5-11, detect whether or not the user has failed to provide any facility specific information and then insert data from the first publicly available data set. The default data module 1240 can either automatically fill in the missing information or the default data module 1240 fill in the missing information in response to a user input (e.g., a response to a query or the user checking the default box 1130, FIG. 11).

Once the system 1200 has obtained the necessary information, a blood usage estimation module 1250 uses the first data set, second data set, facility-specific information, and the default data to estimate the amount of blood and blood product usage, as described above. In addition to estimating the amount of blood and blood product usage, the blood usage estimation module can also perform a variety of mathematical functions to determine such things as a cost of operation or cost savings. The system 1200 may also include a report generation module 1260 that generates a report containing the estimated blood and blood product usage. As described above, the report may also contain, among other things, estimated annual costs, projected usage for a given time period, and estimated cost savings if certain blood processing equipment is utilized. It is important to note that the modules discussed above may be either hardware or software modules.

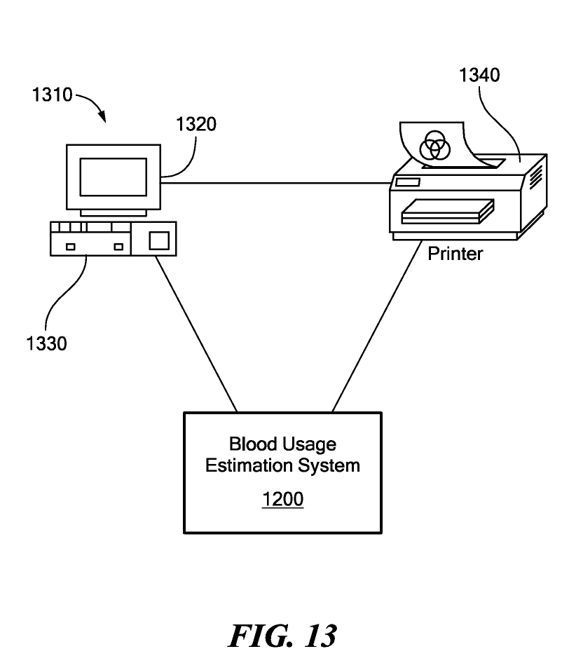

As shown in FIG. 13, the system 1200 may also include a variety of peripherals. For example, the system 1200 may be connected to a user interface 1310 having a display 1320 and a user input device 1330. The system 1200 can use the user interface 1310 to display the user queries (e.g., the system may display the screen shots shown in FIGS. 2-11 on the display 1330) and collect the facility specific data from the user (e.g., from the input device 1330). Although the user input device 1330 is shown as a keyboard, any user input device is within the scope of embodiments of this invention. For example, the user input device 1330 may be a voice recognition system, a mouse, etc. Additionally or alternatively, the display 1320 may be a touch screen display that allows a user to directly input the necessary data. The system 1200 may also be connected to a printer 1340. The printer 1340 allows the system 1200 to print out the report generated by the report generation module 1260.

In accordance with other embodiments of the present invention, the above described systems and methods can be used to control the stocks of blood and blood products in a medical facility. In particular, embodiments of the present invention may obtain usage data (e.g., number of units of blood per procedure, average length of stay per procedure, etc.) regarding the blood usage for a number of different procedures and salvage data regarding blood salvage rates for the procedures and/or particular blood salvage equipment. The usage and salvage data may be publicly available data, similar to the first and second data sets described above. Additionally or alternatively, the usage data may have a first usage data set and a second usage data set and the salvage data may have a first salvage data set and a second salvage data set. The method may then obtain facility-specific data on the anticipated procedures that will be performed at the medical facility over a given period of time (e.g., 3 months). The facility-specific information may also include the cost of blood and blood products to the facility, the number of procedures, the types of procedures, the types of blood salvage equipment used and owned by the facility, etc.

Once the method has obtained the necessary data, the method may process the data to determine a numerical estimate of the medical facility's blood usage over the given period of time. The method may then use the estimated blood usage to determine the stock requirements for the facility (e.g., for the given period of time). In a similar manner to that described above, if certain facility-specific data is missing or unknown, the method can use the usage and/or salvage data (e.g., from the first usage data set and first salvage data set) as defaults for the missing/unknown facility-specific data. The method may also generate a report that contains the estimate of blood usage and the blood and blood product stock requirements described above. In addition to the above, the method may also process the data to determine a numerical estimate of cost savings created by salvaging blood and blood products. In other words, the method can determine how much the hospital can save in blood and blood products if a particular piece of blood salvaging equipment is used.

A system similar to that described with respect to FIG. 12 may be used to implement the above described embodiment of the present invention. In particular, the first data set module 1210 and the second data set module 1220 may be used to obtain the usage data and the salvage data. In alternative embodiments, the first data set module 1210 can be used to obtain the first usage data set and the first salvage data set and the second data set module 1220 can be used to obtain the second usage data set and the second salvage data set. The user query module 1230 may be used to obtain the facility-specific data. If any facility-specific data is missing, unknown, or unable to be provided by the user, the default data module 1240 can fill in the missing information with the appropriate usage data or salvage data. The blood usage estimation module 1250 can process the data to determine a numerical estimate of the blood usage for the medical facility over the given period of time. The blood usage estimation module 1250 may also determine the blood and blood product stock requirements and determine the numerical estimate of the cost savings created by salvaging the blood and blood products. Lastly, as the name suggests, the report generation module 1260 can generate the report containing the estimate of blood usage and the blood and blood product stock requirements.

It is important to note that embodiments of the present invention discussed above help hospitals and other facilities overcome many of the inherent challenges of estimating and predicting blood and blood product usage and maintaining an appropriate stock (e.g., quantity and type) of blood and blood products. In particular, hospitals and other such facilities must be careful to maintain sufficient stock of blood and blood product for any upcoming and/or emergency surgeries. However, many blood and blood products are expensive, have only limited shelf-lives, and cannot be stored for extended periods of time. Therefore, it is not in the financial interests of the hospital to maintain an overly large stock/supply of blood and blood product because if products are not used in a timely manner, some or all of the blood and blood products may need to be disposed, wasting valuable blood and blood products as well as the hospital's money.

Additionally, because the facility may need a variety of blood and blood products (e.g., whole blood, plasma, platelets, white blood cells, etc.) and the type and quantity are dependent upon the procedures that the facility will carry out in a given time period and the amount of blood and blood product that are salvaged during the procedures, it is important to take such information into account when projecting blood usage. For instance, if a particular procedure requires X units of whole blood but the facility has blood salvage equipment that is capable of recovering some or all of the whole blood needed, the hospital will only need enough blood to cover the difference (e.g., the amount of blood needed minus the amount of blood salvaged). Any blood that the hospital alots to this surgery that is above the difference will likely be wasted, unnecessarily increasing the cost to the hospital and the patient.

Additionally, hospitals and other such facilities may use embodiments of the present invention to determine the cost-effectiveness of purchasing a new piece of blood salvage equipment. In particular, hospitals may use embodiments of the present invention to determine if the amount of blood and blood product recovered over a given number of procedures will offset the cost of the piece of blood salvage equipment. In other words, if the blood salvage equipment is able to salvage enough blood and blood product such that the hospital is able to recover the cost of the machine (e.g., they are able save enough money on purchased blood and blood product to offset the cost of the machine), the blood salvage equipment is likely cost-effective.

In one embodiment, the invention may be implemented as a computer program product for use with a computer system. Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may either be a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer systems (e.g., on system ROM or fixed disk), or distributed from a server or electronic bulletin board over the network (e.g., the Internet or World Wide Web).

Although the above discussion discloses various exemplary embodiments of the invention, it should be apparent that those skilled in the art can make various modifications that will achieve some of the advantages of the invention without departing from the true scope of the invention.

We claim:

1. A method for estimating usage of blood and blood products in a facility comprising:
obtaining a first set of publicly available data;
obtaining a second set of publicly available data;
querying a user for data specific to the facility;
using data from the first set of publicly available data as default data for data not provided by the user; and
estimating an amount of blood product usage based upon the first and second set of publicly available data and data entered by the user.

2. A method for estimating blood product usage according to claim 1, further comprising generating a report containing the estimated blood product usage.

3. A method of estimating blood product usage according to claim 1, wherein the data specific to the facility includes the cost of blood product.

4. A method of estimating blood product usage according to claim 1, wherein the data specific to the facility includes a number of surgical procedures performed by a hospital.

5. A method of estimating blood product usage according to claim 1, wherein the first set of publicly available data includes an average units of blood used per procedure.

6. A method of estimating blood product usage according to claim 1, wherein the first set of publicly available data includes an average length of stay.

7. A method of estimating blood product usage according to claim 1, wherein estimating an amount of blood usage includes performing a mathematical function to determine a cost of operation.

8. A method of estimating an amount of blood product usage according to claim 1, wherein estimating an amount blood product usage includes performing a mathematical function to determine cost savings.

9. A computer program product for use with a computer system, the computer program product containing computer code for estimating blood and blood product usage in a facility, the computer code comprising:
computer code for obtaining a first set of publicly available data;
computer code for obtaining a second set of publicly available data;
computer code for querying a user for data specific to the facility;
computer code for using data from the first set of publicly available data as default data for data not provided by the user; and
computer code for estimating an amount of blood product usage based upon the first and second set of publicly available data and data specific to the facility.

10. A computer program product according to claim 9 further comprising computer code for generating a report containing the estimated blood product usage.

11. A computer program product according to claim 9, wherein the data specific to the facility includes the cost of blood product.

12. A computer program product according to claim 9, wherein the data specific to the facility includes a number of surgical procedures performed by a hospital.

13. A computer program product according to claim 9, wherein the first set of publicly available data includes an average units of blood used per procedure.

14. A computer program product according to claim 9, wherein the first set of publicly available data includes an average length of stay.

15. A computer program product according to claim 9, wherein the computer code for estimating an amount of blood usage includes computer code for performing a mathematical function to determine a cost of operation.

16. A computer program product according to claim 9, wherein the computer code for estimating an amount blood product usage includes computer code for performing a mathematical function to determine cost savings.

17. A system for estimating usage of blood and blood products in a facility comprising:
a first data set module configured to obtain a first set of publicly available data;
a second data set module configured to obtain a second set of publicly available data;
a user query module configured to query a user for data specific to the facility;
a default data module configured to detect whether the user has failed to provide any data specific to the facility and use data from the first publicly available data as default data for data not provided by the user; and
a blood usage estimation module configured to estimate an amount of blood product usage based upon the first and second set of publicly available data and data entered by the user.

18. A system according to claim 17 further comprising:
a report generation module configured to generate a report containing the estimated blood product usage.

19. A system according to claim 17, wherein the data specific to the facility includes the cost of blood product.

20. A system according to claim 17, wherein the data specific to the facility includes a number of surgical procedures performed by a hospital.

21. A system according to claim 17, wherein the first set of publicly available data includes an average units of blood used per procedure.

22. A system according to claim 17, wherein the first set of publicly available data includes an average length of stay.

23. A system according to claim 17, wherein the blood usage estimation module is further configured to perform a mathematical function to determine a cost of operation.

24. A system according to claim 17, wherein the blood usage estimation module is further configured to perform a mathematical function to determine cost savings.

25. A system according to claim 17 further comprising:
a user interface having a display device and a user input device, the user interface configured to display queries on the display device and receive inputs from the user via the user input device.

26. A system according to claim 25, wherein the inputs from the user via the user input device includes the data specific to the facility.

27. A system according to claim 25 further comprising a printer configured to print the blood estimation report generated by the report generation module.

28. A system according to claim 25 wherein the user input device is a keyboard.

29. A computer-implemented method for use in controlling stocks of blood and blood products in a medical facility, comprising the steps of:
i. obtaining usage data on the usage of blood for a number of different procedures;
ii. obtaining salvage data on blood salvage rates for said procedures;
iii. obtaining facility-specific data on the anticipated procedures to be performed at the medical facility over a period of time;
iv. processing the data obtained in steps (i) to (iii) to determine a numerical estimate of blood usage for the medical facility over said period of time; and,
v. determining a blood and blood products stock requirement for the medical facility over said period of time in dependence on the estimate of blood usage obtained in step (iv).

30. A computer system for use in controlling stocks of blood and blood products in a medical facility, comprising:
i. means for obtaining usage data on the usage of blood for a number of different procedures;
ii. means for obtaining salvage data on blood salvage rates for said procedures;
iii. means for obtaining facility-specific data on the anticipated procedures to be performed at the medical facility over a period of time;
iv. means for processing the data obtained in steps (i) to (iii) to determine a numerical estimate of blood usage for the medical facility over said period of time;
v. means for determining a blood and blood products stock requirement for the medical facility over said period of time in dependence on the estimate of blood usage obtained in step (iv).
